(19) United States
(12) Patent Application Publication
(10) Pub. No.: US 2011/0315613 A1
(43) Pub. Date: Dec. 29, 2011

(54) Water conservation system

(76) Inventors: Abdullah Saeed Al-Ghamdi, Jeddah (SA); Shafiq S. Al-Attas, Jeddah (SA); Saud A. Gutub, Jeddah (SA)

(21) Appl. No.: 12/801,840

(22) Filed: Jun. 28, 2010

(51) Int. Cl. B01D 29/88

(52) U.S. Cl. 210/104

(57) ABSTRACT

The water conservation system provides for the controlled circulation of heated water between an overhead water tank, which is mounted on the roof of a building, and an underground water tank for storing cooled water. The overhead tank has a feed outlet, a circulation outlet, and a circulation inlet formed therein. A first conduit is provided, with a lower end thereof being positioned within the underground tank. A pump draws water from within the underground tank, which is delivered to a second conduit. An upper end thereof is in fluid communication with the overhead tank. A third conduit is further provided, having an upper end in communication with the overhead tank and a lower end in communication with the underground tank. A programmable valve selectively controls water flow out of the overhead tank, which is delivered, via the third conduit, to the underground tank by gravity.

### BACKGROUND OF THE INVENTION

1. Field of the Invention

The present invention relates to water supply systems, and particularly to a water conservation system for circulating water between an overhead tank mounted on the roof of a building for storing heated water and an underground tank for storing cooled water.

2. Description of the Related Art

Due to shortages in water supplies, the water authorities in many third world cities rely on intermittent water supply systems. In such a system, the city is divided into a number of small sectors, and water is pumped between the sectors according to an operational schedule. The period between water delivery cycles for a given sector could be several days or even weeks.

It is common in such systems for each household to be equipped with an underground tank for storing the water during the pumping period, along with an overhead, or rooftop, tank to balance the pressure in the internal plumbing system. An external pump is provided for pumping the water from the underground storage tank to the overhead tank.

During the daytime, the water in the overhead tank is exposed to direct solar radiation and the water temperature in the tank rapidly warms, particularly in hot climates, where the environmental temperature often exceeds 50° C. during summer months. Depending on the material used in the construction of the overhead tank, and the exposure time of the tank to the solar radiation, the water temperature in the overhead tank is expected to exceed the ambient air temperature. As a result, the water temperature in the plumbing system inside the building may exceed a tolerable temperature for normal residential use, thus causing scalding for residents who attempt to bathe with the heated water.

In order to avoid such problems, residents often open water taps in their apartments during midday hours, keeping the water running for quite some time in order to drain the overheated water so that the overhead tank will refill with cooler water from the underground tank. The hot water that is drained by opening the tap goes into the sewer system, and is lost. This results in the waste of a valuable resource, particularly in climates where intermittent water supplies are necessary.

The waste of the water is particularly accented by the fact that such residences also include the underground tank, which is adapted for maintaining stored water at colder temperatures. The underground positioning of this tank provides thermal insulation from the solar radiation that heats the overhead tank. It would be desirable to provide a system for easily and rapidly circulating the heated water from the overhead tank to the colder underground tank when the heated water is not needed, thus conserving the water supply.

Thus, a water conservation system solving the aforementioned problems is desired.

### SUMMARY OF THE INVENTION

The water conservation system provides for the controlled circulation of water between an overhead water tank, which is mounted on the roof of a building, and an underground water tank. The overhead tank is adapted for storing water therein, and the water stored therein is heated by exposure to ambient sunlight. The overhead tank has a feed outlet, a circulation outlet and a circulation inlet formed therein. A temperature sensor is mounted within the overhead tank for measuring the temperature of the heated water stored therein.

A first conduit having opposed upper and lower open ends is provided. The lower end of the first conduit is positioned within the water stored in the underground tank. A pump that is in fluid communication with the upper end of the first conduit, which passes through a circulation outlet formed through the underground tank, selectively draws water from within the underground tank. This water is then delivered to a second conduit, also having opposed upper and lower open ends. The lower end of the second conduit is in fluid communication with the pump, and the'upper end thereof is in fluid communication with the circulation inlet of the overhead tank. The underground tank has a water feed inlet adapted for connection with an external water supply and a circulation inlet formed therein.

A third conduit having opposed upper and lower open ends is provided. The upper end of the third conduit is in fluid communication with the circulation outlet of the overhead tank, and the lower end is in fluid communication with the circulation inlet of the underground tank. A temperature-controlled valve selectively controls water flow out of the overhead tank, which is delivered, via the third conduit, to the underground tank by gravity. The heated water stored within the overhead tank is circulated to the underground tank when a maximum temperature threshold is reached. The temperature-controlled valve shuts off to stop circulation of water from the overhead tank to the underground tank when the water temperature in the overhead tank falls below the maximum temperature threshold.

Additionally, a controller is preferably provided for selectively actuating the pump and the temperature-responsive valve. The controller preferably includes a water level sensor mounted within the overhead tank so that the pump can be activated if the water level in the overhead tank falls below a set threshold level.

These and other features of the present invention will become readily apparent upon further review of the following specification and drawings.

### BRIEF DESCRIPTION OF THE DRAWINGS

FIG. 1 is a diagrammatic view of a water conservation system according to the present invention.

FIG. 2 is a block diagram illustrating system components of a controller of the water conservation system of FIG. 1.

Similar reference characters denote corresponding features consistently throughout the attached drawings.

### DETAILED DESCRIPTION OF THE PREFERRED EMBODIMENTS

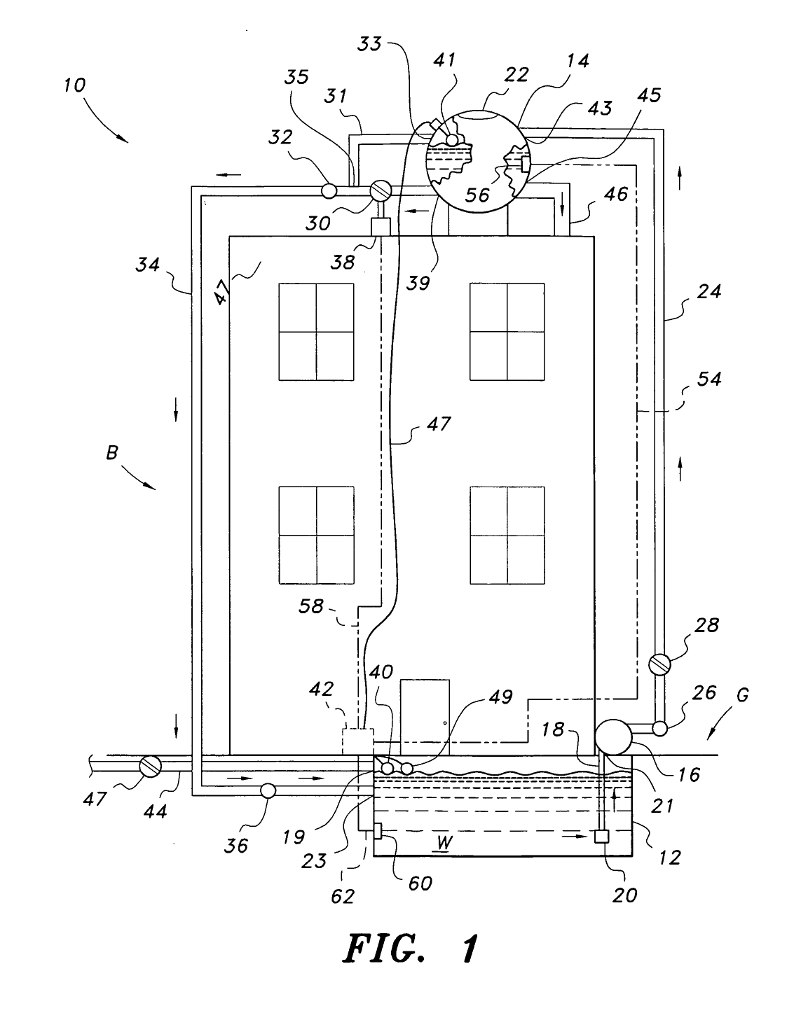

Referring to FIG. 1, the water conservation system 10 provides for the controlled circulation of water between an overhead water tank 14, which is mounted on the roof of a building B, and an underground water tank 12, which is located beneath ground level G. The overhead tank 14 and the underground tank 12 are conventional, and are adapted for storing water therein. It should be understood that building B is shown for exemplary purposes only. Further, it should be understood that tanks 12, 14 are shown diagrammatically for exemplary purposes only, and that tanks 12, 14 may have any suitable configuration, depending upon the needed storage capacity and locations thereof. In regions where intermittent water supplies are common, an arrangement such as that shown in FIG. 1 is typical, where the overhead tank 14 is used for storing water and providing the required water pressure in the plumbing system, and the underground tank 12 is used for storing cool water.

The overhead tank 14 has a feed outlet 45, a circulation outlet 39 and a circulation inlet 43 formed therein. A bypass circulation outlet 33 is also formed therethrough for connection to a bypass pipe 31, as will be described in greater detail below. An inspection cover 22 may be mounted over an open upper end of the tank 14. The feed outlet 45 feeds water into the building via a conduit 46, which may branch off to provide multiple water supplies for the various units (apartments, offices, etc.) within building B, as is conventionally known. Water may feed through conduit 46 under the force of gravity alone, or with the aid of a water pump or the like.

A first conduit 18 (for example, 1-inch diameter PVC pipe), having opposed upper and lower open ends, is provided, with the lower end of the conduit 18 being positioned within the cool water W stored in the underground tank 12. The lower open end may be covered with a water filter 20 or other suitable filter or purifying device. A pump 16 is in fluid communication with the upper end of the first conduit 18, which passes through a circulation outlet 21 formed through the underground tank 12. Pump 16 may be any suitable type of controllable and selectively actuable water pump. Pump 16 is shown as being mounted on the ground G directly above underground tank 12, although it should be understood that the pump 16 may be positioned at any suitable point along the flow path.

Pump 16 selectively draws water W from within the underground tank 12. The water W is delivered to a second conduit 24 (for example, 1-inch diameter PVC pipe), also having opposed upper and lower open ends. The lower end of conduit 24 is in fluid communication with the pump 16, and the upper end of conduit 24 is in fluid communication with the circulation inlet 43 of the overhead tank 14. The underground tank 12 has a water feed inlet 19 adapted for connection with an external water supply, fed by line 44, which may be connected to the public or municipal water supply. A circulation inlet 23 is formed through underground tank 12. As shown, flow control valve 47 regulates the pressurized flow within line 44, and is coupled with a float valve 49, mounted within underground tank 12 to close the feed through line 44 if underground tank 12 is full.

A flow control valve 26 is preferably positioned within the second conduit 24, allowing the user to selectively control the rate of water flow therein. A one-way check valve 28 is also preferably positioned within conduit 24, preventing water from flowing down from the overhead tank back into the underground tank (and further preventing accidental damage to pump 16).

A third conduit 34 (for example, 2-inch diameter PVC pipe), having opposed upper and lower open ends, is provided. The upper end of the third conduit 34 is in fluid communication with the circulation outlet 39 of the overhead tank 14, and the lower end of the third conduit 34 is in fluid communication with the circulation inlet 23 of the underground tank 12. A valve 30 selectively controls water flow out of the overhead tank 14, which is delivered by the third conduit 34 to the underground tank 12 by gravity. Preferably, the valve 30 includes a temperature-responsive actuator 38 for release of the water under user-programmable control. As will be described in greater detail below, a bypass pipe 31 is further provided, the bypass pipe 31 extending between the bypass circulation outlet 33 and a junction 35, allowing flow from the overhead tank 14 to bypass the temperature controlled valve 30.

Cool water is drawn from the underground tank 12 for storage within the overhead tank 14, and the water stored within overhead tank 14 is heated via radiant heat transfer; i.e., through direct exposure to sunlight during the daytime. A temperature sensor 56 is mounted within the overhead tank 14 and is in communication with controller 42 (as will be described in greater detail below) via line 54. The controller 42 is programmed with a desired maximum threshold temperature for the water stored in the overhead tank 14. Continuous monitoring of the temperature in the overhead tank 14 (as well as monitoring of the water in the underground tank 12 via temperature sensor 60, which communicates with controller 42 via line 62) may be performed by controller 42. When the water in the overhead tank 14 exceeds the maximum threshold temperature, the controller 42 opens the valve 30 to allow the water to flow from tank 14 to the cooling underground tank 12.

A flow control valve 32, similar to flow control valve 26, is preferably provided within third conduit 34, providing user control over the rate of water flow through the third conduit 34. An auxiliary flow control valve 36 may be provided underground adjacent the water inlet 23, providing redundancy in the water flow control. Additionally, a bypass conduit 31 leads directly from overhead tank 14 to third conduit 34, bypassing valve 30. As shown, bypass circulation outlet 33 is formed through overhead tank 14, preferably at or above the level of float 41, with bypass conduit 31 extending from port 33 and joining third conduit 34 at junction 35. In case of float failure, conduit 31 will take the excess water by gravity to the underground tank 12 via third conduit 34, without passing through valve 30. Thus, valve 30 only operates according to the user-programmable control, rather than being controlled by the water levels in overhead tank 14 or underground tank 12.

A controller 42 is preferably provided for automatically actuating the pump 16 according to programmed instructions. Controller 42 may be a programmable logic controller or any other suitable type of programmable control system. The controller 42 preferably is in communication with a water level sensor, such as exemplary float switch 41, mounted within the overhead tank 14, so that the pump 16 can be activated if the water level in the overhead tank 14 falls below a pre-set threshold level, and can be automatically shut off when the float switch rises to the desired fill level. Float switch 41 is shown in communication with controller 42 via line 47, although it should be understood that any suitable wireless or wired communication may be utilized. Further, it should be understood that controller 42 may be located at any suitable location. Similarly, a float switch 40 may be mounted within underground tank 12, with float switch 40 also being in communication with controller 42.

It should be understood that first, second and third conduits 18, 24, 34 are shown diagrammatically for exemplary purposes only, and that any suitable types of pipes or the like may be utilized, depending upon the nature of building B, the positioning of tanks 12, 14 and the volume and rate of water flow therein. Similarly, flow control valves 26, 32, 36 may be any suitable type of valves, providing user-control over the flow rate of water within the conduits. Further, it should be understood that one-way check valve 28 may be any suitable type of one-way valve. Actuator 38 controls valve 30, and actuator 38 is in electrical communication with controller 42 via line 58. Similarly, pump 16 is in electrical communication with controller 42, thus allowing controller 42 to programmably release valve 30 and similarly programmably actuate pump 16 to circulate water between tanks 12 and 14. The float sensors 40, 41, also in communication with controller 42, serve as a safety backup system in the event of a water level within tanks 12, 14 being either too high or too low.

As described above, in regions where intermittent water supply systems are utilized, particularly during the summer, when the water temperature stored in overhead tank 14 often exceeds tolerable temperatures for domestic use, the system may be used to conserve water. In a conventional system, the water stored in the overhead tank 14 heats until it exceeds a desired temperature, at which point the residents or building managers are forced to release the overheated water into the environment or sewage system, thus wasting the water. System 10 allows for the circulation of the water into the cooling underground tank when the temperature reaches the desired threshold temperature, thus conserving the water.

Controller 42 is programmed with a maximum threshold temperature for the water stored within overhead tank 14 (with the temperature being measured by temperature sensor 56). When the maximum threshold temperature is reached, the controller 42 generates a signal which is received by actuator 38 (via line 58) to open valve 30, thus causing the water to travel, under the force of gravity, from overhead tank 14 to the cooling underground tank 12. The underground tank 12 has a larger capacity than the overhead tank 14, so that the hot water diverted from the overhead tank 14 may result in some momentary rise in temperature in the underground tank 12, but will eventually be cooled by underground storage.

When a sufficient quantity of water has been drained from the overhead tank 14 to the underground tank 12, the low water level in the overhead tank 14 will cause the controller 42 to actuate the pump 16 to draw cool water from the underground tank 12 into the overhead tank 14, thereby cooling water in the overhead tank 14. When the temperature of the water in the overhead tank 14 drops below the maximum temperature threshold, temperature-controlled valve 30 closes. The pump 16 continues to pump cool water into the overhead tank 14 until the float switch 41 signals the controller 42 that the maximum water level has been reached, whereupon the controller 42 shuts down the pump 16. The controller 42 permits the resident to program the maximum threshold temperature to control when the valve 30 opens and closes.

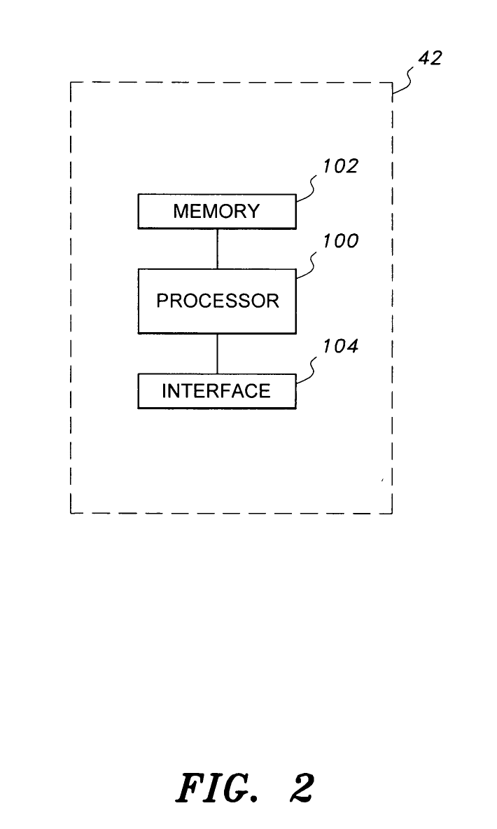

It should be understood that the controller 42 may be any suitable type of controller, such as a programmable logic controller or the like, or any suitable computer system, such as that diagrammatically shown in FIG. 2. Commands, such as the threshold levels, are entered into processor 100 via any suitable type of user interface 104 (which may also include any suitable type of display), and may be stored in memory 102, which may be any suitable type of computer readable and programmable memory. Calculations are performed by processor 100, which may be any suitable type of computer processor and may be displayed to the user on a display associated with interface 104, which may be any suitable type of computer display.

Processor 100 may be associated with, or incorporated into, any suitable type of computing device, for example, a personal computer or a programmable logic controller. The display, the processor 100, the memory 102 and any associated computer readable recording media are in communication with one another by any suitable type of data bus, as is well known in the art.

Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 102, or in place of memory 102, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Overhead tank 14 provides water pressure for the interior water supply (via line 46). Float sensor 41 measures the water level within the overhead tank 14 and delivers measurement signals to controller 42. If the measured water level within overhead tank 14 drops below a pre-set level threshold, there will be insufficient water pressure for the interior sinks, toilets, etc. When controller 42 determines that the measured water level within overhead tank 14 has dropped below the pre-set threshold, valve 30 is closed (if open) to prevent further water loss, and pump 16 is actuated to draw water from underground tank 12 to fill the overhead tank 14 until float sensor 41 measures a sufficient water level within overhead tank 14. Once a maximum, pre-set threshold level has been reached within overhead tank 14, controller 42 deactivates pump 16. As a further alternative, bypass conduit 31 is provided so that if float sensor 41 fails, or if there is a failure in the programmable valve 30, valve 30 is bypassed, allowing water to drain from overhead tank 14 into underground tank 12 via pipe 34, thus preventing accidental overfilling of overhead tank 14.

Communication with float sensor 40 within the underground tank 12 allows controller 42 to send similar control signals to pump 16, thus preventing accidental overfilling of underground tank 12. Float sensor 40 further allows for the measurement of water provided by the municipal water supply via line 44, and further allows for the balance of water pressure between overhead tank 14 and underground tank 12, thus acting as an additional safety measure.

Instead of a controller 42, the temperature-controlled valve 30 may be opened and closed by a water thermostat, and the pump 16 may be activated and deactivated directly by the float switch 41.

It is to be understood that the present invention is not limited to the embodiment described above, but encompasses any and all embodiments within the scope of the following claims.

We claim:

1. A water conservation system, comprising:
an overhead tank adapted for mounting on a roof of a building, the overhead tank being adapted for storing water therein, the overhead tank having a feed outlet, a circulation outlet, and a circulation inlet formed therein, wherein the water stored therein is at least partially heated by exposure to ambient sunlight;
an underground tank adapted for storing cool water therein, the underground tank having a circulation inlet and a circulation outlet formed therein;
a supply conduit system connecting the circulation outlet of the underground tank to the circulation inlet of the overhead tank;
a recirculation conduit system connecting the circulation outlet of the overhead tank to the circulation inlet of the underground tank;
a pump disposed in the supply conduit system for pumping water from the underground tank to the overhead tank;
a temperature-controlled valve disposed between the overhead tank circulation outlet and the recirculation conduit system;
a water temperature sensor disposed in the overhead tank, the water temperature sensor being connected to the temperature-controlled valve and operable to open the temperature-controlled valve to recirculate hot water from the overhead tank to the underground tank when water temperature in the overhead tank exceeds a prescribed maximum temperature and operable to close the temperature-controlled valve when the water temperature in the overhead tank is at or below the prescribed maximum temperature; and
a water level sensor disposed in the overhead tank, the water level sensor being connected to the pump and operable to activate the pump to pump cool water from the underground tank to the overhead tank when the water in the overhead tank falls below a prescribed low level, and operable to shut off the pump when the water level in the overhead tank rises to a prescribed full level.

2. The water conservation system as recited in claim 1, further comprising a controller connected between said temperature-controlled valve and said water temperature sensor, the controller being programmable and having means for user selection of the prescribed maximum temperature.

3. The water conservation system as recited in claim 2, wherein said pump and said water level sensor are connected to said controller, whereby said low level and said full level are programmable.

4. The water conservation system as recited in claim 1, wherein said water level sensor comprises a float switch.

5. The water conservation system as recited in claim 1, further comprising a bypass conduit system connecting the overhead tank and the underground tank, the bypass conduit system providing for drainage from the overhead tank to the underground tank in case of failure of said water level sensor when the water level exceeds the full level.

6. The water conservation system as recited in claim 1, further comprising a distribution conduit system connected to the feed outlet of said overhead tank, the distribution conduit system being adapted for supplying water to the building upon demand.

7. A water conservation system, comprising:
an overhead tank adapted for mounting on a roof of a building, the overhead tank being adapted for storing water therein, the overhead tank having a feed outlet, a circulation outlet, and a circulation inlet formed therein, wherein the water stored therein is at least partially heated by exposure to ambient sunlight;
an underground tank adapted for storing cool water therein, the underground tank having a circulation inlet and a circulation outlet formed therein;
means for recirculating hot water from the overhead tank to the underground tank when water temperature in the overhead tank exceeds a prescribed maximum temperature; and
means for supplying cool water from the underground tank to the overhead tank when the water in the overhead tank falls below a prescribed water level.

8. The water conservation system according to claim 7, wherein said means for recirculating comprises:
a recirculation conduit system extending from said overhead tank to said underground tank;
a temperature-controlled valve disposed between said overhead tank and the recirculation conduit system, the temperature-controlled valve having an open position permitting water to flow from said overhead tank to said underground tank when the water temperature in the overhead tank exceeds the prescribed maximum temperature, and having a closed position preventing water from flowing through the recirculation conduit system when the water temperature in the overhead tank is at or below the prescribed maximum temperature.

9. The water conservation system according to claim 8, wherein said means for recirculating further comprises a water temperature sensor connected to said temperature-controlled valve.

10. The water conservation system according to claim 9, wherein said means for recirculating further comprises a controller connected between said water temperature sensor and said temperature-controlled valve.

11. The water conservation system according to claim 10, wherein said controller is programmable, having means for user selection of the prescribed maximum temperature, means for switching said temperature-controlled valve to the open position when the water temperature in the overhead tank exceeds the prescribed maximum temperature, and means for switching said temperature controlled valve to the closed position when the water temperature in the overhead tank is at or below the prescribed maximum temperature.

12. The water conservation system according to claim 7, wherein said means for supplying comprises:
a water level sensor disposed in said overhead tank;
a supply conduit system extending between said underground tank and said overhead tank; and
a pump disposed in the supply conduit system, the pump being connected to the water level sensor, the pump being actuated to pump cool water from said underground tank to said overhead tank when the water level sensor detects that the water in the overhead tank has fallen below a prescribed water level and shut off when the water level sensor detects that the water in the overhead tank has risen up to a full level.

13. The water conservation system according to claim 12, wherein said water level sensor comprises a float switch.

14. The water conservation system according to claim 12, wherein said means for supplying further comprises a controller connected to said water level sensor and to said pump, the controller actuating and shutting off said pump in response to signals received from said water level sensor.

15. The water conservation system according to claim 7, wherein:
said means for recirculating comprises:
a recirculation conduit system extending from said overhead tank to said underground tank;
a water temperature sensor disposed in said overhead tank;
a temperature-controlled valve disposed between said overhead tank and the recirculation conduit system; and
a controller connected to the water temperature sensor and the temperature-controlled valve; and
said means for supplying comprises:
a water level sensor disposed in said overhead tank, the water level sensor being connected to the controller;
a supply conduit system extending between said underground tank and said overhead tank; and
a pump disposed in the supply conduit system, the pump being connected to the controller;
wherein the controller is programmed to open the temperature-controlled valve when the water temperature in the overhead tank exceeds the prescribed maximum temperature and to close the temperature-controlled valve when the water temperature in the overhead tank is at or below the prescribed maximum temperature; and
wherein the controller is programmed to actuate the pump in order to pump cool water from said underground tank to said overhead tank when the water level sensor detects that the water in the overhead tank has fallen below a prescribed water level, and to shut off the pump when the water level sensor detects that the water in the overhead tank has risen up to a full level.
